(19) United States
(12) Patent Application Publication
(10) Pub. No.: US 2006/0162664 A1
(43) Pub. Date: Jul. 27, 2006

(54) Pet Bedding Kit

(75) Inventor: Ellen Baer, blaine, WA (US)

Correspondence Address: ELLEN BAER, PO BOX 83793, SAN DIEGO, CA, 92138, US

(73) Assignee: Ellen Baer, Blaine, WA (US)

(21) Appl. No.: 10/905,834

(22) Filed: Jan. 22, 2005

(51) Int. Cl. A01K 1/035

(52) U.S. Cl. 119/28.5

(57) ABSTRACT

The invention is a pet bedding kit that is primarily designed for feline usage, although smaller pets of other species may find it accommodating. The ‘kit’ is comprised of a newly designed bed, offering different sizes from kitten to BIG Kitty size, that allows for felines to enjoy a variety of relaxing and sleeping positions from stretched out to curled-up. It accomplishes a comfortable and relaxing area for cats to rest, sleep, or observe. The rectangular shaped bed has a built-in pillow and body support (a type of poly-fil) at one end with a mattress that fits the remainder of the bed. There is a small pre-sewn pocket near the tail end of the bed that is unnoticeable. A cloth ‘packet’ containing herbs or flowers that cats enjoy is put into the pocket. Two differently styled-types of pillows are included; a flatter pillow and puffy pillow proportionate to the bed size and anticipated size and weight of the cat. The mattress of the bed considers the weight and size of the intended cats usage, as well. There is a theme or coordination of fabric choice that completes the bed kit, including the color(s) or pattern(s) of the fabric of all bed kit components, as well as, the size, shape and fillings.

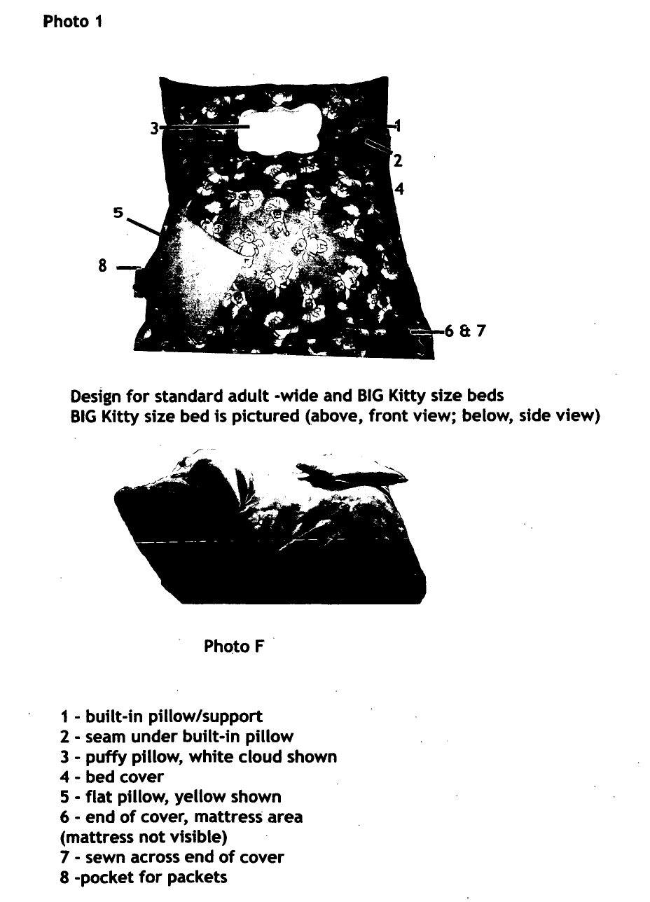

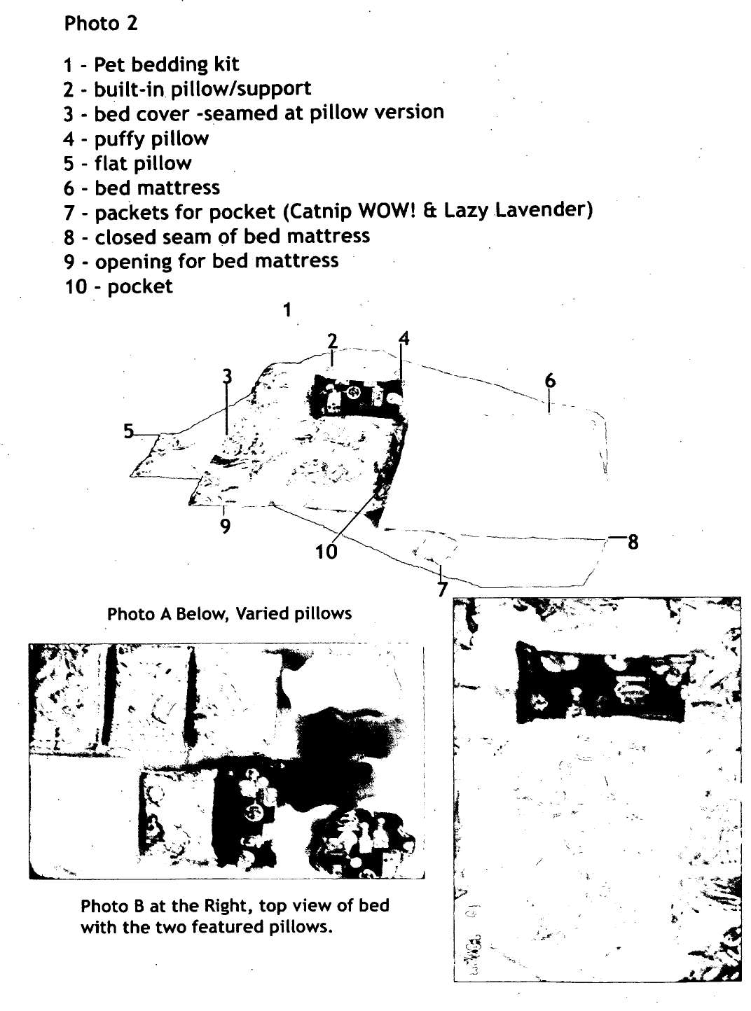

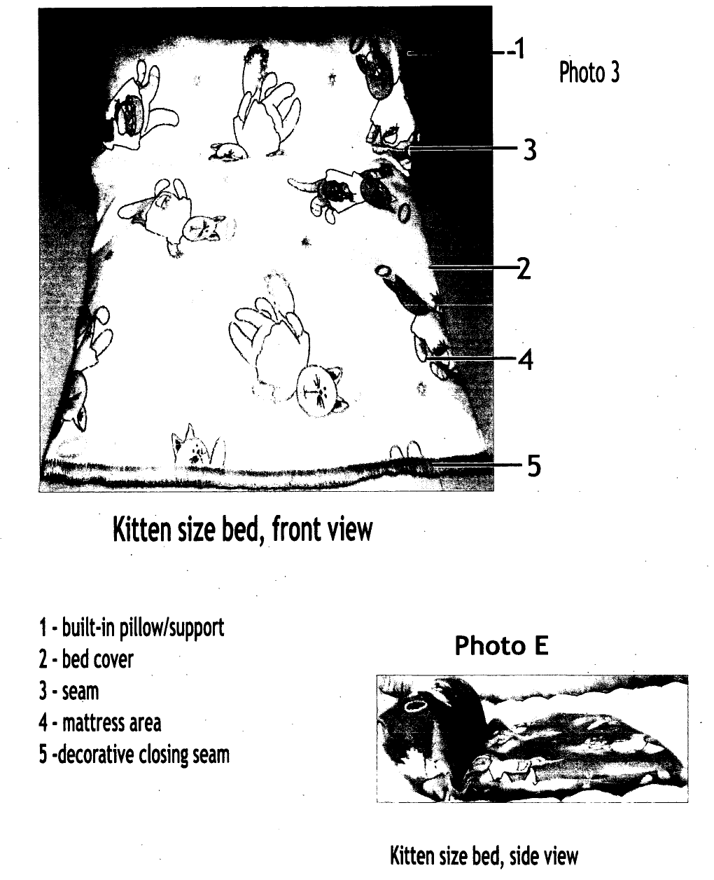

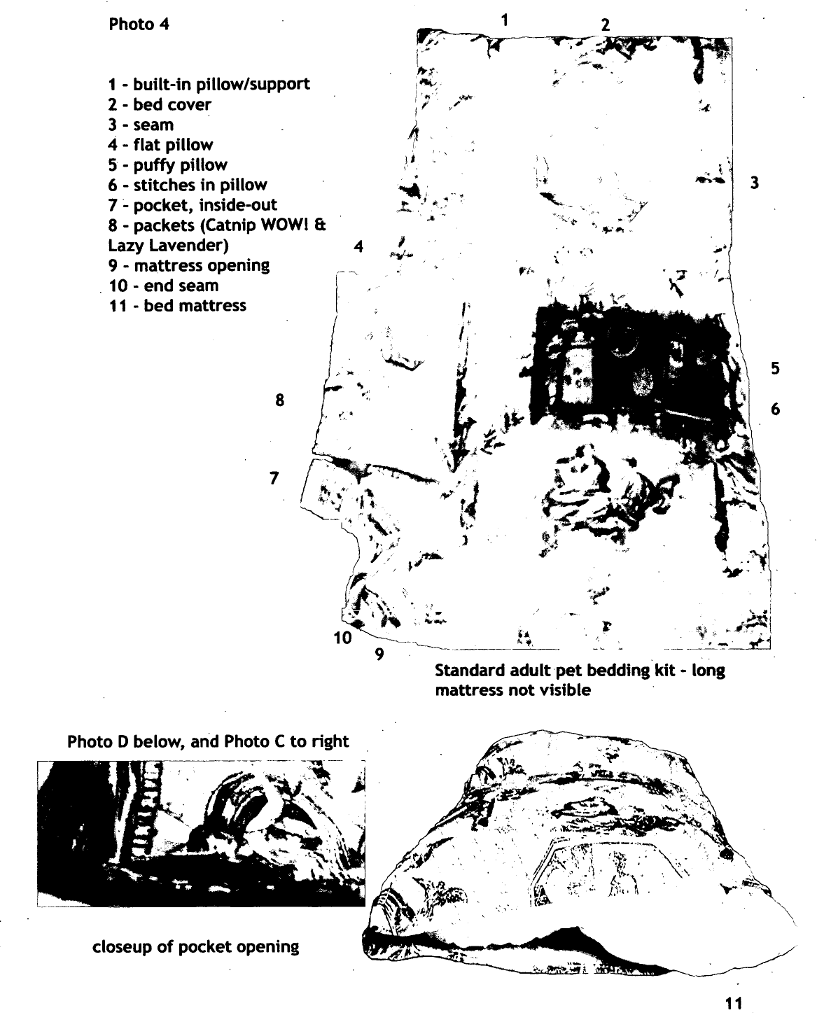

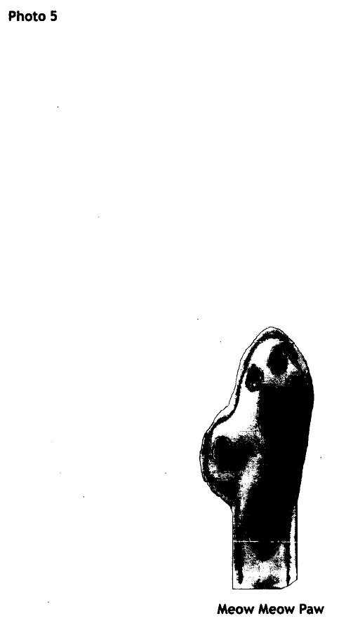

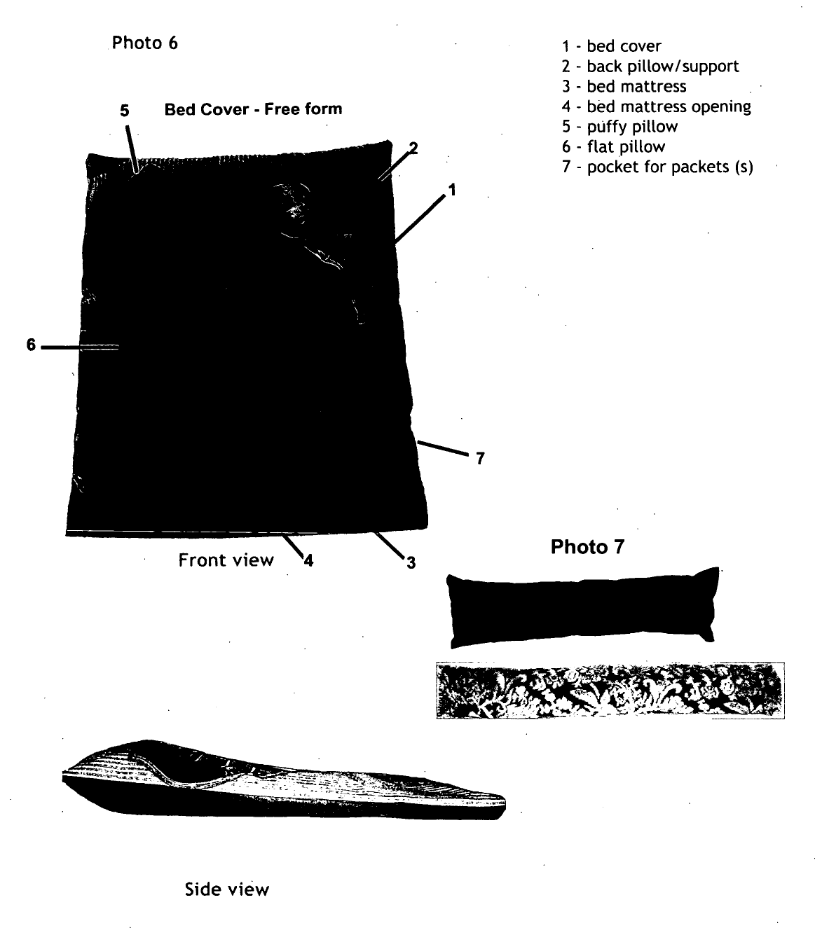

### BACKGROUND OF THE INVENTION

I first designed this bed kit for a wonderful cat friend of mine. She, as many cats, that I have observed over a long period of time, enjoys stretched out positions while relaxing or sleeping. Most cat beds sold in pet stores or other retail are only one size, they generally have a similar design which is a round or oval shaped bed apparatus that is enclosed by a soft side wall (e.g.: foam), many inches from the base. Whereby, this is good for a ‘curling’ up position, when it comes to a stretched out position not all of the cat can fit in the bed.

Cats, vary in size and length, even as full grown adults they can differentiate in weight from 5 pounds to 30 pounds, or so. My cat friend would use her old bed, a conventional bed type to curl up on but when she wanted to stretch out and sleep would move to the carpeted area near her bed or another designated sleeping area that was not confined. I have observed the same with other cats that I have lived with, in non-caged shelters, and else where.

Cats enjoy pillows. The cats that have lived with me have used standard bed pillows, meant for persons, to lay their heads on, as well as, small throw pillows used for decor. They have also used their own paws, one on top of the other and then rested their head on top of the stacked paws. With my first design attempts for my cat friends I made them pillows that were the flatter and puffy styles. Included in this kit are the same; they enjoy resting their heads and upper portion (chest and arm area—on a flatter pillow) of themselves on them, and in other positions.

In U.S. Pat. No. 5,724,911 by McAlister his art work is of a rounded shape pet bed with a cat curled up in it; this is a typical cat bed shape. In another U.S. Pat. No. 6,196,157 by Northrop, she has invented what she terms a ‘nestable pet bed’ which is a round or oval designed bed with sidewalls that have an entry/exit space. Where these are nice beds, they do not consider the various stretched out positions that cats rest or sleep as a norm. This later invention considers the “pets” size because the sidewalls are designed to flare out; a larger pet could rest his/her body against these sidewalls.

The pet bedding kit invention considers the cats body size, weight and varied normal sleeping positions, thus allowing for the optimum comfort, support and normal habits for the cat without restriction. This invention also offers olfactory enhancements provided with the packets from the kit, as well as, consideration that cats enjoy resting their heads and chests on varying depth pillows. These are differences between this invention and the previous noted invention art.

There have been various pet mats and beds created that allow for various types of insect repellants, herbs or flower essences (for homeopathic means) to be inserted into the respective apparatus. Included are U.S. Pat. No. 4,763,604 by Meekins, and U.S. Pat. No. 6,173,675 by Licciardo. Looking at their prior art, these inventions respectively, use a round and mat shaped apparatus' that have accessible built-in compartments or areas that allow for fillers such as: natural pest repellants, stimulating herbs or relaxant oriented flowers to be inserted. There are large cavities for these fillers as part of their design. The intent and respective affect is associated with the type of filler inserted, but essentially to assure that the filler has the intended profound affect on the pet who uses the apparatus.

With the bed kit invention, the herbs/flowers used is a component of the design to enhance the sleeping area and rest/sleep experience. The idea of the small pocket sewn (˜2″×2″) into the bed is unique; though the idea of using herbs/flowers such as catnip or lavender to enhance this affect is not new as noted above. Licciardo's pet mat contains various types of herbs including catnip in an effort to ‘stimulate’ the cat for a limited period of time. They also have an alternative mat that uses, in part, lavender to ‘subdue’ the cat. Also, note the cat bed by McAlister that contains layers of polyester and that the herbs are inserted into the layers. There is also a no mess refillable catnip toy that Bartleson, U.S. Pat. No. 5,653,196 whose invention uses pre-sewn cotton bags filled with catnip. These are used for cat toys that have a Velcro opening/closing so that the toy will last longer and retain catnip without spillage. Our packets offer the same idea but for the reasons listed above, the packets for our beds are snugly inserted into the bed cover pocket without a Velcro or other type of closing mechanism. The pocket can sit above or below the mattress.

The pet bedding kit is good for traveling as well. It can be rolled up and out with the pillows included similarly to a beach towel. It is light weight and does not take up a lot of room and is cushiony for automobile drives. They can also be used in outdoor cat houses when protected from the outdoor elements.

### BRIEF SUMMERY OF THE INVENTION

This is a unique bedding solution for cat comfort. It considers the shape, movement, weight, and size of cats in its design. The bedding kit is comprised of multiple components whereby each component considers the other to obtain the goal. The components considered are the bed cover, mattress, flatter pillow, puffy pillow, and the packets of herbs or flowers and its position in the bed cover, though considered it is not an imperative part of the design as not all cats are attracted to herbs or flower scents. Cats inhale smell not only through their noses but through an area located in the upper portion of their mouth.

### BRIEF DESCRIPTION OF VIEWS OF DRAWINGS

Photo 1: Basic kit design for adult size cat beds. Front view of bed cover with pillows.

Photo F: Side view of adult size bed with pillows.

Photo 2: Disassembled -bedding -kit for adult size cat, all components. Top view.

Photo A: Pillows with various shapes and fabrics indicative of what may be included with adult size bedding kit. Top view.

Photo B: Top view of adult size bed with two featured pillows.

Photo 3: Top view of kitten bed.

Photo E: Side view of kitten bed.

Photo 4: Standard Long bedding kit for adult cat, top view.

Photo D: Side view and close up of pocket in adult size cat bed cover.

Photo C: Side view of adult size cat bed cover with mattress partially out.

Photo 5: Front view of a Meow Meow Paw, cat toy.

Photo 6: Top view of Free Form bed cover with pillows; and below side view of Free Form bed cover.

Photo 7: Top view of Pillows used for either the Free Form bed cover, on top of adult size cat bed or can be used with other cat bedding.

### DETAILED DESCRIPTION OF THE INVENTION

There are 4 adult sized bed kits with varying themes or coordinates which include:

A solid popular color fleece with a cloud shaped puffy pillow and a flat pillow that compliments the color of the bed. The pillow fabric either matches or compliments the color of the bed.

A toile print cotton fabric with pillows, flat and puffy, that compliment the pattern choice. In this instance, a shape within the fabric pattern may be used for the flat pillow with the same fabric or one that compliments that fabric.

A primarily blue flannel material with a pattern of cat angels in the clouds (mostly blue with yellow, white, etc.) This choice comes with a white cloud pillow and a flat yellow or same fabric pillow. This choice is also available in pink for the kitten size beds only.

An off white textured cotton with cotton print pillows; featuring bright and fun designs. Summer fruits, happy cats and the like with the flat pillow mimicking a design of one of the fruits or the like from the fabric pattern.

These are current themes/coordinated efforts. The bed kits attempt to consider the various tastes of people and the times. And would like the bedding not only to be comfortable and appealing to the cat but to the people as well. With regard to the cats: usage of known pattern types that may affect the cats vision in a negative manner would not be used; and patterns or colors that would be of interest to the cat would be considered. In conjunction with the consideration for the caretakers of the cats to have options of fabric choices that will compliment the decor in their home. For persons who are indecisive about getting beds for their cats because they may be apprehensive on the ‘look’ of it, this may open the door. Only fashionable fabric choices will be considered. Because of this the fabric, themes and coordinates will change over time. Note: Extra pillows may be added separately, should that enhance the individual cats comfort.

There are 13 components to the adult sized kits, they are:
size of bed
fabric type (feel, appearance, durability, temperature & environmental factors)
pattern and/or color of fabric
shape of bed
bed cover
built-in pillow/support
mattress
bed pocket
packets (CatNip WOW! and Lazy Lavender)
flatter pillow
puffy pillow
filling of mattress, and pillows
theme/coordinated effect

The idea is to create either a theme or a visually coordinated effect of the bedding kit based on the fabric, its patterns, color, shape of pillows and bed. A simple example might include a fabric with a leaf pattern; the flatter pillow could be the shape of one of the leaves in the pattern of that fabric. (See Photos 2 & 4 for bedding kits)

This is a pet bedding kit and therefore all components are considered for the overall comfort for the cat. There are three adult bed types, and some overall variance in the design including fabric choice and size. Each component has been considered in respect to each of the other components.

This includes, for example, the mattress (note in Photo 2). It is either a quilted 100% cotton or poly-cotton blend shell, note that the color can vary to match or compliment the bed cover including the color white. Mattress stuffing will consist of a type of poly-fil; or fleece may be used as filling. All sides are enclosed and it is machine washable. The amount of stuffing is dependent on the size of the mattress for its coordinated bed cover, the larger the bed, the more stuffing or fleece. Depth and density are considered in the mattress with relationship to the built-in pillow, flatter & puffy pillows, and anticipated size and weight of the cat. The mattress inserts into the bed cover and is covered by it. The mattress could be affixed to the inside of the bed cover using a Velcro or another device that would accomplish the same; allowing for the mattress to be attached, in essence, to the bed cover; or it can simply be set into the bed cover.

As is the case for the bed cover (built-in) pillow. Having the ‘built-in’ pillow within the bed cover is part of the design; additionally there is a Free Form bed cover that allows for a pillow to be inserted into the bed cover. This pillow would be the width of the bed cover itself. It has the same affect with regard to the goal of the invention and how it operates. This is a design primarily used due to fabric type or print and for other aesthetic reasons. (Photo 6)

The puffy pillow, white cloud shown (Photo A & Photo 1); this sized pillow is for either of the two standard adult beds. It's approximate size is 5″×6″×2.5″. The BIG Kitty size is 6″×7″×3″. These pillows are stuffed with a type of poly-fil and are machine washable. Another version of a puffy pillow (Photo 4, #5), note stitching (#6). These pillows use a variety of stitches and thread and can vary slightly in design. Their shapes and sizes may vary according to the theme of the bed kit or fabric of bedding used.

The flatter pillow, (Photo 4, #4 & Photo A) is about ½ to 1 inch in depth and for the standard adult size beds, approximately 5″×6″. For the BIG Kitty size, it is about 7″×8″. These pillows are stuffed with quilt batting (poly-fil) or fleece fabric and use a variety of stitches and ways of stitching it allowing for various aesthetic effects and durability, and the cats comfort.

The bed cover will normally be 100% cotton, flannel, or fleece fabric (Photos B, 1, & 6) and the bed covers' built-in pillow/support (Photos 1, #1 and 4, #1) stuffed with a type of poly-fil. The usage of non-absorbent materials for outside beds, such as a deck. For example, a vinyl cotton may be used for the underside of a non-reversible bed cover and the upper portion may be cotton or fleece. The remainder of the cover will fit the mattress which is inserted at the bottom of the bed (Photo C, and 2 #6). Although, weight and size of the cat are considered with each bedding kit design. There is additional room for those who choose to add to the bedding an additional mattress (perhaps for a geriatric cat) with lesser poly-fill/fleece fill then the original mattress. The bed cover has a pocket (Photos 4, #7 and Photo D) sewn into it; this is where one of the packets (Photo 4, #8) is inserted.

The built-in pillow/support for the cat allows for one of two uses. It acts as an area to rest the head and/or a support for the cat to lay up against; either in a stretched out position or a curled up position. From my observations of my and many other cats I have noted that cats like to stretch out when they feel safe to sleep; particularly in warmer weather.

Other pillows may be added to the kit or acquired separately. This would include a long tubular pillow, which might sit upon the bed cover freely. (Photo A and Photo 7)

There are two types of packets, Catnip WOW! and Lazy Lavender. (Photos 2 and 4)
Catnip WOW! consists of: various choices of catnip including organic or natural catnip buds, catnip pellets, whole catnip leaves, chopped leaves, stems and buds.
Lazy Lavender consists of: organic or natural lavender flowers.

The Catnip WOW! ingredients are considered a stimulant to a cat when eaten or inhaled. This stimulated affect, in most cats who respond to it lasts for few to several minutes, afterwards the cat usually enjoys relaxing or sleeping. Lazy Lavender, an organic lavender sensation, is considered to act, homeopathically, as a sedative or a relaxant. Only a small amount of lavender is in the packet being careful not to overdue the affect of the flowers' aroma. The packet pockets are only sewn into the adult and BIG kitty beds, not the kitten beds. The pet bedding kit comes with one packet of each type. It is not required to use a packet, this is left to the discretion of the cats caretaker. Packets are replaceable.

The kitten bed (Photos 3 and E) is similar to the adult beds but scaled down in size. Additional differences are: it does not have a separate mattress or a packet pocket. This is a bed created for a young kitten up to 3 or so months old. The kitten bed is comprised of a type of poly-fil in the built-in pillow/support, the mattress section is enclosed and is comprised of poly-fil batting and a type of poly-fil. Other alternatives are discussed later. In lieu of the standard cat pillows, a Meow Meow Paw toy (Photo 5) is included.

The inventor believes that at this early age, small pillows would be perceived as toys. The bed is a resting place and it would be advantageous to its caretakers for the kitten to get accustomed to a pet bed as opposed to other human oriented furnishings in the home, unless of course, that is ok with its caretakers. In any case, it is the inventors contention that having the kitten become acquainted with having it's own space and in this case, bed at an early age is good for everyone.

Confusing it with too much stimuli such as herbs and/or flowers and pillows would not be helpful in establishing this bed as a resting place for a feline this age. The Meow Meow Paw toy is included for the kittens' pleasure away from the bed (this version would not contain catnip or another stimulant/relaxant.)

The comfort and appeal of the bed kit are the primary concerns. It is the belief that this invention will achieve the ultimate comfortable experience for most cats who use an indoor bed or who have never had an indoor bed.

This invention considers in its design the following, which I have not seen or located by researching prior patented art; A Pet Bedding Kit, designed for felines and potentially suitable for other small animals. Size, weight and physique of feline reflected in design of kit components. Potential diversity in felines resting/sleeping positions (i.e.; stretched out, curled up and in-between). Cats appreciation of pillows (built-in pillow/support and loose pillows, allowing for head and upper body support). A built-in pocket within the bed cover where a pre-filled packet of aromatic herbs or flowers that cats have been known to enjoy is inserted to enhance the bedding experience. Usage of fabrics with varying textures, that consider the temperature of the environment, as well as, placement of the bedding, and aesthetics of the feline and their caretaker.

Versatility of Pet Bedding Kit; it can also be used for traveling and inside protected outdoor cat houses that do not have extreme climatic temperatures.

What is claimed is:

1. I claim: This is a unique design of a pet bedding kit comprised of multiple components, each component considers the other in its relationship to the feline physique for sleeping and resting positions, This includes:
a) Multiple sized bed covers with associated mattresses which insert into the bed cover for adult cats. The shape and size of the bed cover allow the cat to lie from a curled up position to a stretched out position with room on the bed for the entire body of the cat;
b) A built-in or inserted pillow the width of the adult sized cat bed cover where the amount of stuffing is in part based on the size and weight of the cat. The built-in pillow serves multiple purposes: a support for any portion of the cats body; whether they lay against or partially over it, a head pillow, a neck rest;
c) A pocket sewn into the bed cover that lays either over or under the mattress whereby packets of herbs or flowers that cats traditionally enjoy are inserted into;
d) A packet of catnip products and a packet of lavender come with the bed kit and are inserted into the pocket of the bed; this is intended to increase the attractiveness of the bed to the cat; and the pleasure of the cats' experience upon the bed;
e) A variety of fabrics used which consider the tactile and visual aesthetics of the cat, and of the caretaker; as well as, environmental conditions;
f) The adult size cat mattress is stuffed either to the size of the bed kit design anticipating a heavier weighted cat or multiple cats for the BIG Kitty size and smaller weighted single cats for the standard sized designs. Though multiple stuffing amounts are considered (offered) for the standard size adult cat bed mattresses as well;
g) Two types of pillows are included with each adult size cat bed kit; puffy and flatter pillows: A puffy pillow is sized to its respective size bed cover. It is firm and will support the neck and head of the cat. A flatter pillow is sized to its respective size bed cover and its intended usage is for the cat to perch its upper body onto;
h) There is a kitten bed, a smaller simplified version of the adult size cat bed cover & mattress. This bed gives the kitten its own resting, sleeping area preparing it for future use of cat beds as an adult, and other cat furniture;
i) This kitten bed has a built-in pillow the length of the bed; the mattress is sewn into the bed covering;
j) This kitten bed comes with a toy paw, Meow Meow Paw, that is filled with poly-fil or the like.
